(19) United States
(12) Patent Application Publication
(10) Pub. No.: US 2012/0230288 A1
(43) Pub. Date: Sep. 13, 2012

(54) METHOD AND APPARATUS FOR TRANSMITTING CONTROL INFORMATION IN HETEROGENEOUS WIRELESS NETWORKS

(75) Inventor: Sungjin Suh, Seoul (KR)

(73) Assignee: Pantech Co., Ltd., Seoul (KR)

(21) Appl. No.: 13/508,459

(22) PCT Filed: Nov. 9, 2010
(86) PCT No.: PCT/KR2010/007886

§ 371 Date: May 7, 2012

(30) Foreign Application Priority Data
Nov. 9, 2009 (KR) 10-2009-0107744

(51) Int. Cl. H04W 72/04

(52) U.S. Cl. 370/329

(57) ABSTRACT

The present invention provides a method and an apparatus for transmitting and receiving control information in heterogeneous wireless networks. According to one embodiment of the present invention, a method for transmitting control information in heterogeneous wireless networks comprises the steps of, in a wireless communication system in which two or more component carriers are used: generating a control signal to be transmitted at a second component carrier of a frequency domain, which is different from a first component carrier that transmits a control signal in a macro base station; and transmitting the control signal to the second component carrier.

### CROSS-REFERENCE TO RELATED APPLICATIONS

This application is the National Stage Entry of International Application No. PCT/KR2010/007886, filed on Nov. 9, 2010 and claims priority from and the benefit of Korean Patent Application No. 10-2009-0107744, filed on Nov. 9, 2009, both of which are hereby incorporated by reference for all purposes as if fully set forth herein.

### BACKGROUND

1. Field

The present invention discloses a method and a system for transmitting and receiving control information in such a manner as to avoid the signal interference of another wireless network in heterogeneous wireless communication networks.

2. Discussion of the Background

Forms of base stations which are expected in the future can include a form in which local base stations of various types exist together with an existing macro base station. For example, local base stations of various forms, such as a femto cell, a pico cell, a relay node, a hotspot and the like, can exist together within a cell of one macro base station. In this environment, signal interference can occur between base stations having different configurations. Accordingly, there is a need for a method capable of mitigating or minimizing this interference.

### SUMMARY

Therefore, the present invention is intended to provide a method and an apparatus for transmitting control information in a wireless communication system.

Also, the present invention is intended to effectively mitigate interference caused by another base station in an environment where multiple small base stations are concentrated and form a cluster.

Also, the present invention is intended to minimize interference between base stations by causing a scheme for operating a frequency band in which a macro base station transmits a PDCCH (Physical Downlink Control CHannel) to differ from a scheme for operating a frequency band in which a local base station transmits a PDCCH.

In order to accomplish the above-mentioned objects, in accordance with an aspect of the present invention, there is provided a method for transmitting a control signal in a femto system combined with a macro network. The method includes: including a control signal in a component carrier in a frequency domain identical to a frequency domain where a component carrier, through which only data is transmitted among two or more component carriers used by the macro base station, is located; and transmitting the control signal included in the component carrier.

In accordance with another aspect of the present invention, there is provided a method for transmitting a control signal in a femto system combined with a macro network. The method includes: when the number of usable component carriers that a macro base station is capable of using is equal to N, and the number of component carriers used by the macro base station is equal to K (K<N), including a control signal in a component carrier in a frequency domain identical to a frequency domain where any one of (N-K) component carriers that the macro base station does not use, is located; and transmitting the control signal included in the component carrier.

In accordance with another aspect of the present invention, there is provided a method for transmitting a control signal in a femto system combined with a macro network. The method includes: including a control signal in a component carrier in a frequency domain identical to a frequency domain where an extended component carrier among two or more component carriers used by the macro base station, is located; and transmitting control signal included in the component carrier.

In accordance with another aspect of the present invention, there is provided a method for transmitting a control signal in a femto system combined with a macro network. The method includes: including a PDCCH in a component carrier in a frequency domain identical to a frequency domain where a component carrier, which does not include a PDCCH among two or more component carriers used by the macro base station, is located; and transmitting the PDCCH included in the component carrier.

In accordance with another aspect of the present invention, there is provided a method for transmitting control information in a wireless communication system using two or more component carriers in an environment of heterogeneous wireless networks. The method includes: generating a control signal to be transmitted through a second component carrier in a frequency domain different from a frequency domain where a first component carrier, through which a macro base station transmits a control signal, is located; and transmitting the control signal through the second component carrier.

In accordance with another aspect of the present invention, there is provided a femto system combined with a macro network. The femto system includes: including a control signal in a second component carrier in a frequency domain identical to a frequency domain where a first component carrier among two or more component carriers used by a macro base station is located; and transmitting the control signal included in the second component carrier, wherein the first component carrier corresponds to any one of a component carrier through which data is not transmitted, an extended component carrier, an unallocated component carrier, and a component carrier which does not include a PDCCH.

In accordance with another aspect of the present invention, there is provided a method for receiving control information in an environment of heterogeneous wireless networks. The method includes: receiving a control signal that a femto system transmits through a first component carrier, by a user equipment connected to a wireless communication system using two or more component carriers, wherein the first component carrier is located in a frequency domain different from a frequency domain where a second component carrier, through which a macro base station transmits a control signal, is located.

In accordance with another aspect of the present invention, there is provided a user equipment. The user equipment includes: the user equipment, being connected to a wireless communication system using two or more component carriers, for receiving a control signal that a femto system transmits through a first component carrier, wherein the first component carrier is located in a frequency domain different from a frequency domain where a second component carrier, through which a macro base station transmits a control signal, is located.

In transmitting a control signal by each of local base stations, such as a femto base station, a pico base station and the like, which are implemented by the present invention, it is possible to minimize interference caused by a macro base station or a neighboring local base station, and it is also possible to solve a problem of an existing ACCS (Autonomous Component Carrier Selection).

Also, in order to stably transmit control information, a local base station combined with a macro base station first identifies whether a control signal is included in a component carrier transmitted by the macro base station and then transmits a control signal. Accordingly, it is possible to prevent the occurrence of interference between the control signals.

Particularly, interference between control signals can be mitigated when the present invention is applied to a cluster base station having a high density thereof due to a group formed by local base stations combined with a macro base station or a local base station combined with the macro base station.

### BRIEF DESCRIPTION OF THE DRAWINGS

FIG. 1 is a view showing a form in which cell coverages of heterogeneous networks overlap.

FIG. 2 is a view showing a configuration of component carriers of an LTE-A system.

FIG. 3 is a view showing a cell environment where local base stations are concentrated and form a cluster.

FIG. 4 is a view showing an example where a cluster base station transmits a control signal in such a manner as to avoid a component carrier, through which a macro cell transmits a control signal, according to an embodiment of the present invention.

FIG. 5 is a view showing an example where a cluster base station transmits a control signal through a component carrier in a frequency domain which is not used by a macro cell, according to another embodiment of the present invention.

FIG. 6 is a view showing an example where a cluster base station transmits a control signal through a component carrier that a macro cell uses as an extended component carrier, according to still another embodiment of the present invention.

FIG. 7 is a view showing an example where a cluster base station allocates control information to a PDCCH and transmits the control information allocated to the PDCCH in such a manner as to avoid a component carrier through which a macro cell transmits control information allocated to a PDCCH after allocating the control information to the PDCCH, according to yet another embodiment of the present invention.

FIG. 8 is a flowchart showing a process of transmitting control information in an environment of heterogeneous wireless networks according to an embodiment of the present invention.

### DETAILED DESCRIPTION OF THE ILLUSTRATED EMBODIMENTS

Hereinafter, exemplary embodiments of the present invention will be described in detail with reference to the accompanying drawings. It should be noted that in assigning reference numerals to elements in the drawings, the same elements will be designated by the same reference numerals although they are shown in different drawings. Further, in the following description of the present invention, a detailed description of known functions and configurations incorporated herein will be omitted when it may make the subject matter of the present invention rather unclear.

In addition, terms, such as first, second, A, B, (a), (b) or the like may be used herein when describing components of the present invention. Each of these terminologies is not used to define an essence, order or sequence of a corresponding component but used merely to distinguish the corresponding component from other component(s). It should be understood that if it is described in the specification that one component is “connected,” “coupled” or “joined” to another component, a third component may be “connected,” “coupled,” and “joined” between the first and second components, although the first component may be directly connected, coupled or joined to the second component.

Also, a description of the present invention is intended for a wireless communication network. Operations in the wireless communication network may be performed in a process where a system (e.g. a base station) for controlling the relevant wireless communication network controls the network and transmits data, or may be performed by a user equipment connected to the relevant wireless communication network.

For the application of the present invention, a case where heterogeneous wireless communication networks overlap, will be described below. For a detailed description of the present invention, a case will be described as an example where a wireless communication network (a macro cell) having a wide area of coverage complies with LTE-A (Long Term Evolution-Advanced). Heterogeneous wireless communication networks existing in such a manner that coverage areas of the heterogeneous wireless communication networks overlap an LTE-A area, include a micro cell network, a pico cell network, a femto cell network, a relay network, and a hotspot network. For the convenience of the description, the description is focused on a femto cell network. However, the present invention is not limited to the LTE-A or the femto cell network, and is intended for a case where the heterogeneous wireless communication networks overlap.

A macro network and a network other than the macro network overlap. The network other than the macro network is characterized by having transmission/reception power lower than that of the macro network, or by having a cell coverage smaller than that of the macro network. The present invention proposes an embodiment for accurately delivering control information between networks (other than the macro network) which overlap the macro network.

The heterogeneous wireless communication networks according to the present invention have a function of an LTE-A base station, and simultaneously, have a function of a micro cell base station, a function of a pico cell base station, a function of a femto cell base station, a function of a relay base station, and a function of a hotspot base station. Hereinafter, in an embodiment of the present invention, a description is focused on a femto base station combined with a macro base station. The femto base station corresponds to an embodiment of the network other than the macro network as described above. Although the description is focused on the femto base station in an embodiment of the present invention, the technical idea of the present invention can be applied to all of the micro cell network, the pico cell network, the femto cell network, the relay network and the hotspot network, which overlap the macro network. Therefore, the present invention is not limited to this embodiment.

As described above, in order to increase spectral efficiency and extend a cell coverage, the heterogeneous networks including nodes having various RF (Radio Frequency) coverages can be applied to the LTE-A system.

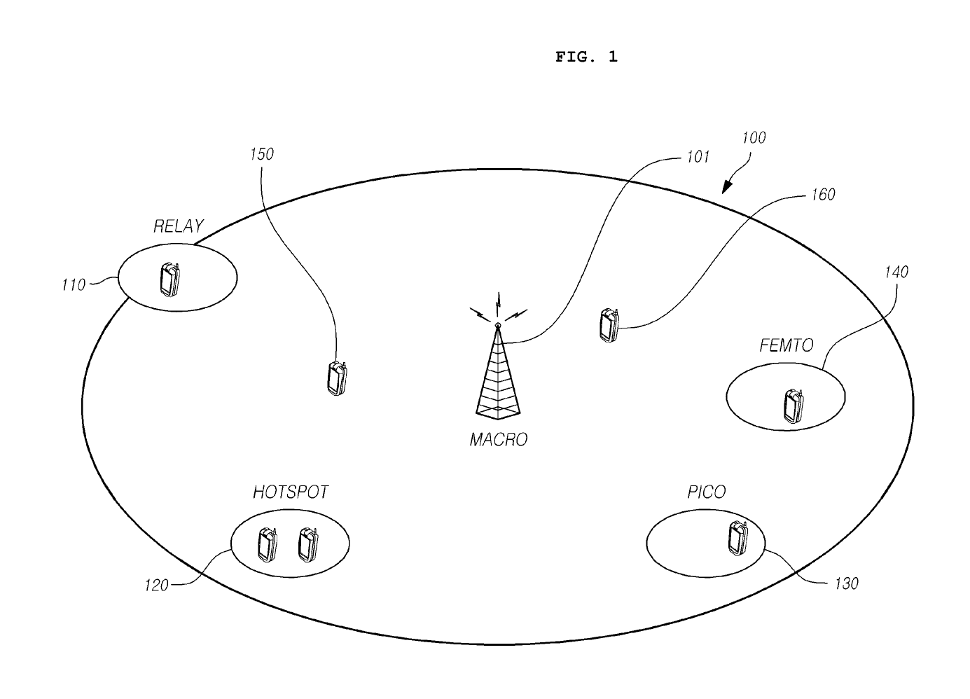

FIG. 1 is a view showing a form in which cell coverages of heterogeneous networks overlap.

FIG. 1 shows a cell environment where local base stations exist together within a cell coverage 100 of a macro base station 101. A User Equipment (UE) which is connected to a relevant cell among local base stations, such as a micro cell, a pico cell 130, a femto cell 140, a relay node 110 and a hotspot 120, is connected to the relevant local base station, and transmits/receives data. Each of UEs 150 and 160 which is not connected to a local base station, is connected to the macro base station, and transmits/receives data.

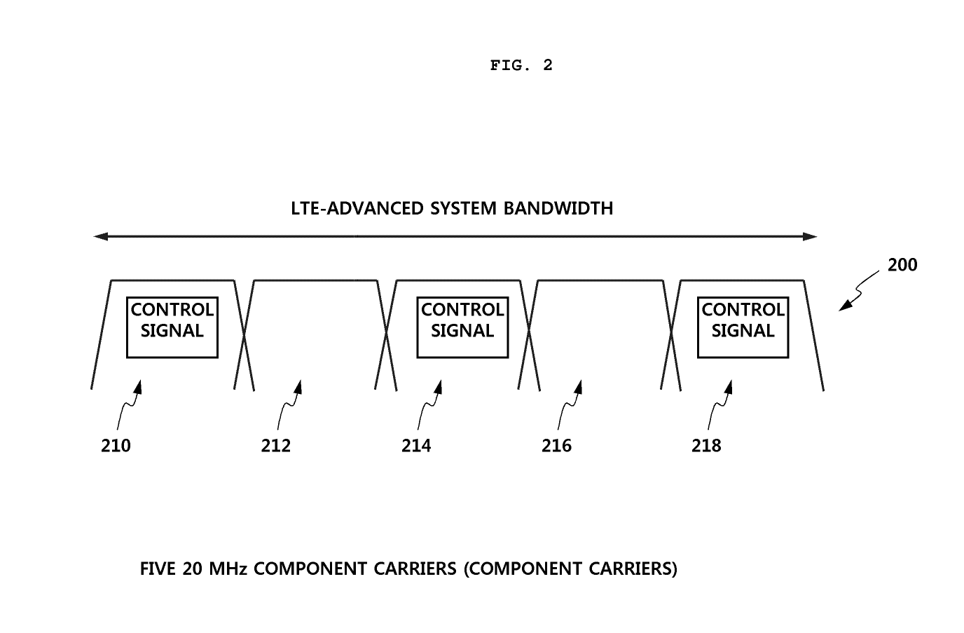

FIG. 2 is a view showing a configuration of component carriers of an LTE-A (Long Term Evolution-Advanced) system.

An LTE-A system corresponding to an embodiment applied to the macro network supports the transmission/reception of data within 100 MHz by using five 20 MHz Component Carriers (CCs) 210, 212, 214, 216 and 218. In this case, the five component carriers may have different characteristics from each other, and may not be continuous. Generally, the component carriers are divided into a backward compatible component carrier (BC) supporting LTE corresponding to a previous system and a non-backward compatible component carrier (NBC) which is not compatible with the previous system. Also, the component carriers may be divided into a component carrier, through which a control signal is transmitted, and a component carrier, through which a control signal is not transmitted. Referring to FIG. 2, a control signal is transmitted through each of first, third and fifth component carriers 210, 214 and 218 among the five component carriers, and only data is transmitted/received through each of remaining second and fourth component carriers 212 and 216 thereamong without transmitting/receiving a control signal. A component carrier through which a control signal is not transmitted, is connected to a component carrier through which a control signal is transmitted, and is subjected to control over data. For example, data of the second component carrier 212 may be controlled by the control signal of the first component carrier 210, and the data of the fourth component carrier 216 may be controlled by the control signal of the third component carrier 214 or the fifth component carrier 218. As described above, according to the characteristics of component carriers which have been discussed in the LTE-A system, a control signal and actual data do not have to exist in an identical component carrier. It goes without saying that a component carrier which does not include a control signal does not necessarily have to be adjacent to a component carrier including a control signal. The LTE-A system is commonly applied to base stations, such as a macro base station and a femto cell. As noted in FIG. 2, although the configuration of component carriers proposes the five component carriers, this configuration is only an embodiment of the present invention. Accordingly, multiple component carriers, the number of which is not 5, may be used in the macro network. Hereinafter, although a description is focused on the five component carriers in embodiments of the present invention, the present invention is not limited to this configuration. Accordingly, the number of component carriers may be variously changed according to the characteristic of a network.

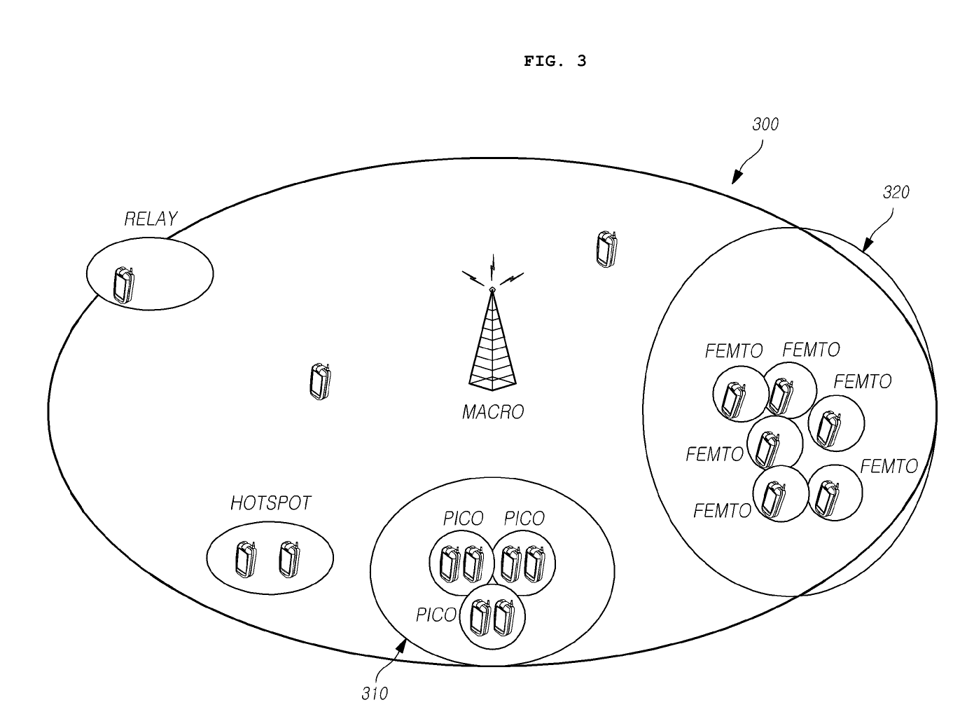

FIG. 3 is a view showing a cell environment where local base stations are concentrated and form a cluster.

FIG. 3 shows a case where different local base stations exist together within a cell coverage 300 of the macro base station. Particularly, a femto base station and a pico base station may be concentrated and may operate as one group. Referring to FIG. 3, a group 310 in which three pico base stations are combined, and a group 320 in which six femto base stations are combined, may operate as one group. In an embodiment of the present invention, a base station formed in such a manner that local base stations (i.e. small base stations), such as femto base stations or pico base stations, are concentrated as a group or a set, is referred to as a “cluster base station.”

Autonomous Component Carrier Selection (ACCS) may be applied to heterogeneous networks so that the component carriers described with reference to FIG. 2 may appropriately operate in the environment as shown in FIG. 1 where the macro base station and the local base stations other than the macro base station exist together. The ACCS implies that a base station first makes a decision for itself and then selects and autonomously configures component carriers. When a base station has a low density, the allocation of the best component carrier to each base station by cell planning can ensure the efficiency and stability of data transmission. However, when the macro base station and local base stations other than the macro base station exist together at predetermined intervals and the density of base stations becomes higher, the ACCS scheme and the cell planning scheme do not show a big difference in performance therebetween. Accordingly, when operational complexity and other expected costs are considered, the ACCS scheme is considered as an appropriate scheme.

However, differently from the consideration of the ACCS scheme as an appropriate scheme in the case (see FIG. 1) where the local base stations are distributed at predetermined intervals, the ACCS cannot show appropriate performance in circumstances (see FIG. 3), such as a campus, a school, a company or the like, where multiple base stations (e.g. femto cells) are concentrated. This is because the ACCS scheme may be applied to a typical local base station in consideration of interference caused by an external macro network whereas all interferences caused by neighboring femto cells must be considered as well as interference caused by the macro base station in an environment where the local base stations (e.g. femto cells) are concentrated.

In an embodiment of the present invention which will be described below, an example of configuring a partial ACCS will be described. The ACCS implies that a base station can first make a decision for itself and can then select and autonomously configure component carriers. When the macro base station and local base stations other than the macro base station exist together at predetermined intervals and the density of base stations becomes higher, the ACCS scheme and the cell planning scheme do not show a big difference in performance therebetween. Accordingly, when operational complexity and other expected costs are considered, the ACCS scheme is considered as an appropriate scheme. In the following embodiments of the present invention, when a component carrier of a femto cell is determined, the component carrier of the femto cell is determined in such a manner as to avoid collision with a component carrier determined by the macro cell base station. This scheme is defined as a partial ACCS. Under the condition that there is no collision with the macro cell base station or there is no difficulty in avoiding the collision with the macro cell base station, the ACCS scheme enables the selection of a component carrier. This description explains the meaning of the partial ACCS.

Hereinafter, an example of transmitting/receiving a control signal will be described. A control signal may include control information.

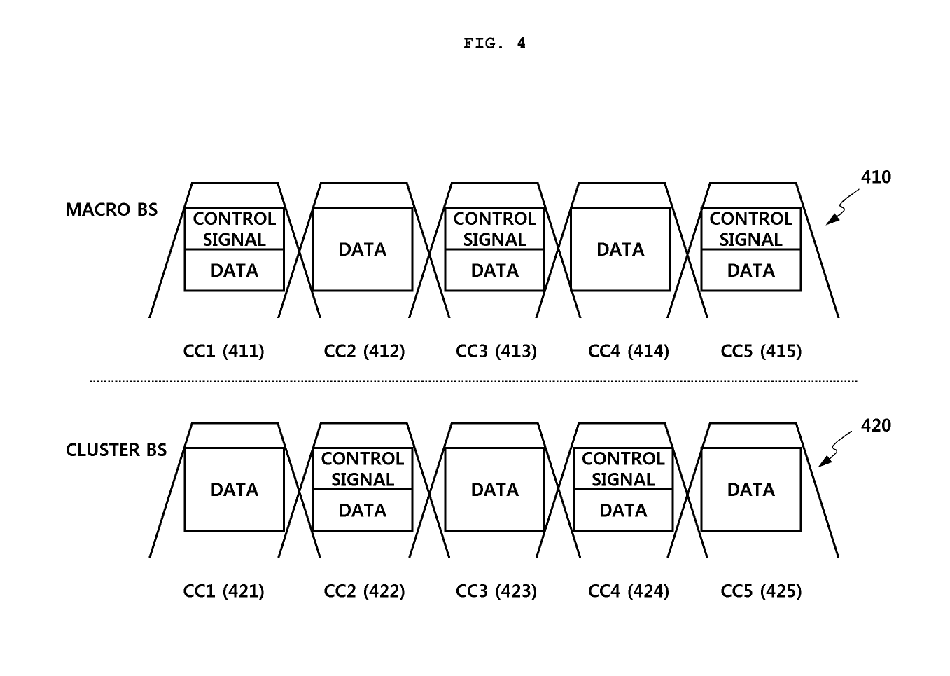

FIG. 4 is a view showing an example where a cluster base station transmits a control signal in such a manner as to avoid a component carrier, through which a macro cell transmits a control signal, according to an embodiment of the present invention.

FIG. 4 is a view showing a configuration for allocating a component carrier by using the partial ACCS. As shown in FIG. 4, the macro base station uses five component carriers 411, 412, 413, 414 and 415 as denoted by reference numeral 410. Also, control signals are not transmitted through all of the component carriers, but control signals are first included in the CC1 411, the CC3 413 and the CC5 415, which are some component carriers, respectively and are then transmitted through the CC1 411, the CC3 413 and the CC5 415. According to an embodiment of the present invention, when the cluster base station transmits control signals as denoted by reference numeral 420, after the cluster base station identifies information on component carriers, through which the macro base station transmits control signals, it first allocates control signals thereof to component carriers 422 and 424, through which the macro base station does not transmit control signals, and then transmits the control signals allocated to the component carriers 422 and 424.

In order to allocate control signals to component carriers different from the component carrier in which the macro base station includes the control signals, respectively, there is a need for a process where the cluster base station identifies which component carriers the macro base station first allocates the control signals to and then transmits the control signals through, respectively. In the present invention, the following four schemes may be used to identify whether a control signal has been allocated to a component carrier.

1) As an embodiment of the present invention, the allocation of a control signal may be identified in a scheme for selecting a particular component carrier after detecting a signal of the macro cell. The cluster base station detects which component carrier the macro base station transmits a control signal through, and selects a component carrier, through which the macro base station does not currently transmit a control signal. In this case, each of local base stations which form the cluster base station, must include an apparatus capable of detecting a control signal of the macro base station.

2) As an embodiment of the present invention, in a scheme for receiving information on the allocation of control signals to component carriers, through a gateway or a particular server which is superior to the local base stations forming the cluster base station, the relevant cluster base station receives information on component carriers that the macro base station including the relevant cluster base station does not use to transmit control signals. Because a femto cluster base station is connected to a LAN (Local Area Network), the femto cluster base station may receive information on component carriers which are not used to transmit control signals from a gateway or a server through a wire. A cluster base station other than the femto cluster base station receives the information in the same manner as a typical scheme for receiving information from an upper layer gateway or an upper layer server.

3) As an embodiment of the present invention, there is a scheme in which the macro base station first includes information on component carriers, which the macro base station does not use to transmit control signals, in broadcasting information transmitted by it, and then transmits the broadcasting information including the information on the component carriers. The cluster base station may receive the broadcasting information, may identify the information on the component carriers which the macro base station does not use to transmit the control signals, and may select a component carrier, through which a control signal of the cluster base station is to be transmitted.

4) As an embodiment of the present invention, there is a cell planning scheme. According to the cell planning scheme, in order to enable a cluster base station existing within a cell coverage of each macro base station to stably transmit a control signal, each macro base station gives priority to a particular component carrier, and enables the cluster base station to first occupy a component carrier. According to the cell planning scheme, in order to use a relevant component carrier to transmit a control signal of the macro base station, the macro base station first identifies whether the cluster base station uses the relevant component carrier to transmit a control signal.

Through the process as described above, the cluster base station first identifies the component carriers which the macro base station does not use to transmit the control signals, and then selects a component carrier, through which a control signal of the cluster base station is to be transmitted. At this time, when the characteristics of a component carrier, which the cluster is base station may select in order to transmit a control signal, is set to have the characteristics of a component carrier, through which a control signal may not be transmitted, a configuration is changed, so as to transmit the control signal through the relevant component carrier.

Meanwhile, control signals according to the present invention are largely divided into a PDCCH (Physical Downlink Control CHannel), a PHICH (Physical Hybrid Automatic Repeat-reQuest (HARQ) Indicator CHannel), and a PCFICH (Physical Control Format Indicator CHannel). Also, in a process implemented by the present invention, a control signal may include only a PDCCH.

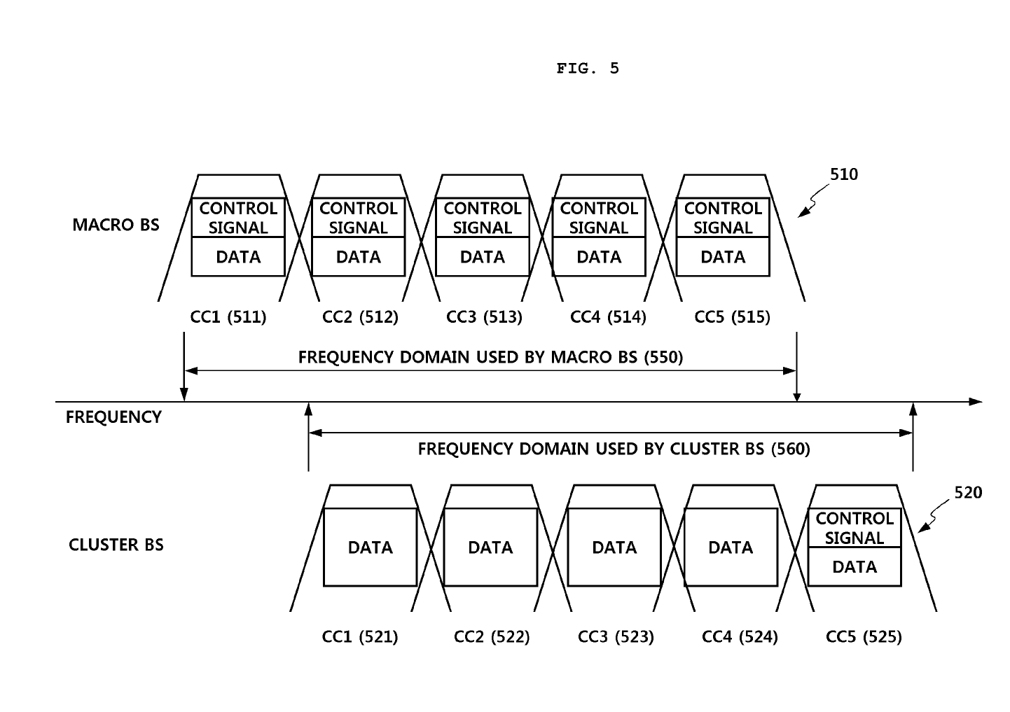

FIG. 5 is a view showing an example where a cluster base station transmits a control signal through a component carrier in a frequency domain which is not used by a macro cell, according to another embodiment of the present invention.

FIG. 5 shows another example of implementing a partial ACCS. When the macro base station or local base stations configures five component carriers by using five or more frequency bands, the cluster base station may utilize an extra frequency band as a component carrier for transmitting a control signal, as shown in FIG. 5.

Referring to FIG. 5, a frequency domain 550 of component carriers used by a macro base station differs from a frequency domain 560 of component carriers used by the cluster base station. Accordingly, the cluster base station may allocate data to component carriers 512, 513, 514 and 515 in the frequency domain used by the macro base station, and may transmit the data through component carriers 521, 522, 523 and 524. In contrast, the cluster base station may allocate a control signal to a component carrier 525 in a frequency domain, which the macro base station does not use, and may transmit the control signal through the component carrier 525. A component carrier in the frequency domain which the macro base station does not use, is named an “unallocated component carrier.”

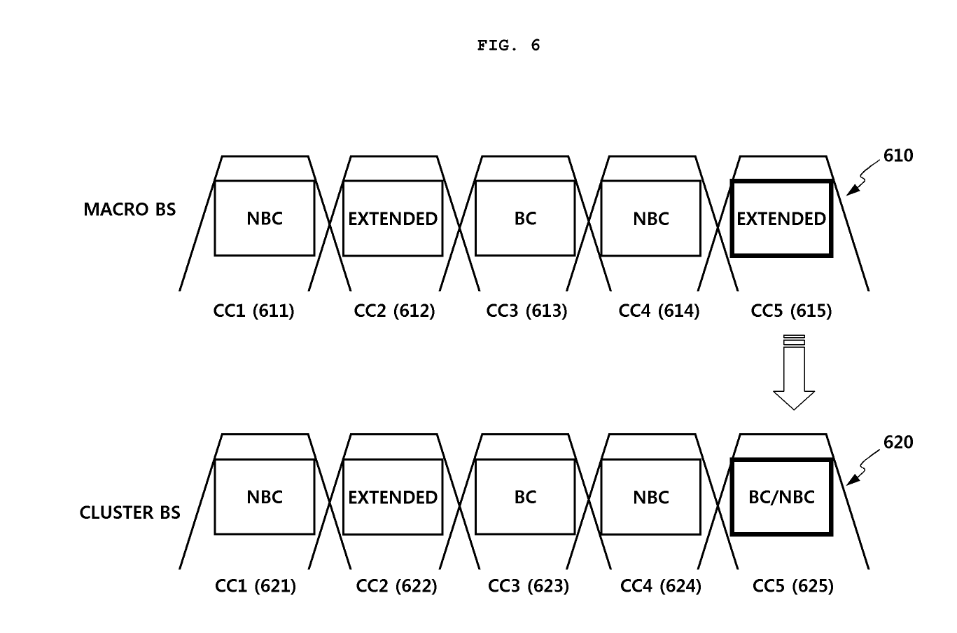

FIG. 6 is a view showing an example where a cluster base station transmits a control signal through a component carrier that a macro cell uses as an extended component carrier, according to still another embodiment of the present invention.

FIG. 6 is a view showing a still another example of implementing a partial ACCS based on characteristics of component carriers. Referring to FIG. 6, NBC signifies a non-backward compatible component carrier, to which users of the existing version (LTE) may not access. Also, BC signify a backward compatible component carrier, to which the users of the existing version (LTE) may also access. Each of a non-backward compatible component carrier and a backward compatible component carrier includes a control signal. In contrast, because an extended component carrier is a component carrier which does not include a control signal, it may not be used as a single component carrier, and is always used in connection with another component carrier.

Accordingly, in order to avoid interference between control signals according to an embodiment of the present invention, the cluster base station selects and uses all or some of extended component carriers which are being used by the macro base station, as backward compatible component carriers or non-backward compatible component carriers. On the other hand, when the macro base station uses all or some of the extended component carriers, which is being used by it, as extended component carriers, because a control signal is not transmitted through a relevant component carrier, the cluster base station may first allocate a control signal to the relevant component carrier and may then transmit the control signal through the relevant component carrier. Accordingly, it is possible to effectively eliminate interference caused by a control signal transmitted by the macro base station.

Referring to FIG. 6, it can be noted that in such a manner as to avoid a CC1 611, a CC3 613 and a CC4 614 corresponding to non-backward compatible component carriers or backward compatible component carriers of the macro base station, the cluster base station uses a CC5 625 corresponding to a backward compatible component carrier or a non-backward compatible component carrier, in a frequency domain of a CC2 612 and a CC5 615 that the macro base station use as extended component carriers.

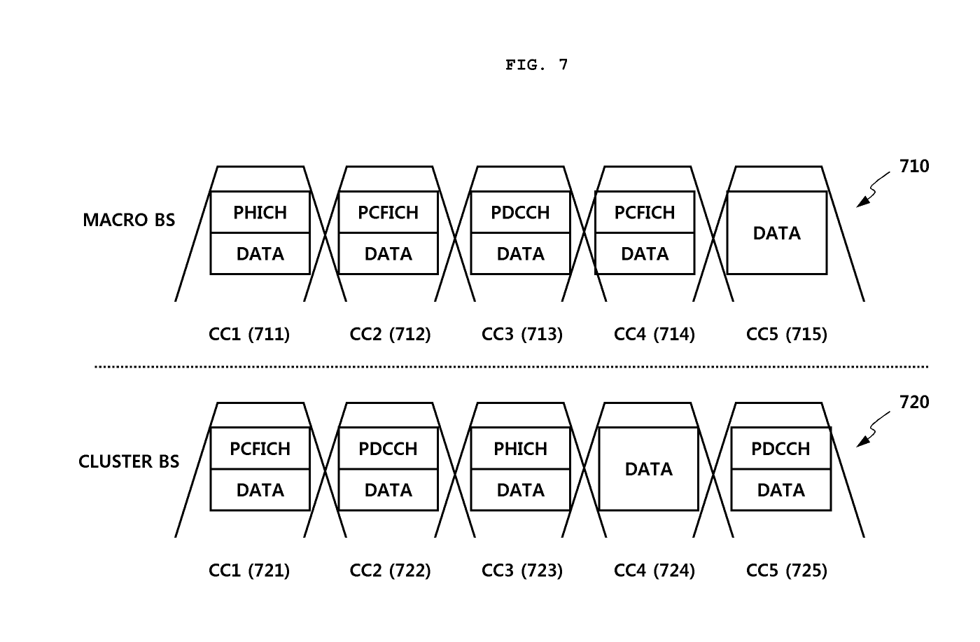

FIG. 7 is a view showing an example where a cluster base station allocates control information to a PDCCH (Physical Downlink Control CHannel) and transmits the control information allocated to the PDCCH in such a manner as to avoid a component carrier through which a macro cell transmits control information allocated to a PDCCH after allocating the control information to the PDCCH, according to yet another embodiment of the present invention.

In the present invention, channels which are first allocated control signals and then the control signals are transmitted through, include a PDCCH (Physical Downlink Control CHannel), a PHICH (Physical Hybrid Automatic Repeat-reQuest (HARQ) Indicator CHannel), and a PCFICH (Physical Control Format Indicator CHannel). A PDCCH among these channels for transmitting control information is allocated DCI (Downlink Control Information) corresponding to downlink control information that all user equipments refer to. Accordingly, when compared with another channel, the accuracy of data transmission is important for the PDCCH. Therefore, when it is difficult to avoid the overlap of all channels allocated control signals from the viewpoint of data transmission efficiency, a client base station may select a component carrier in such a manner as to avoid the overlap of PDCCHs.

The macro base station allocates control information and data to multiple component carriers 711, 712, 713, 714 and 715, as denoted by reference numeral 710. In order to avoid an overlap with the component carrier CC3 713 including the PDCCH as denoted by reference numeral 710, the cluster base station includes a PDCCH in each of a CC2 722 and a CC5 725, as denoted by reference numeral 720. A PCFICH and a PHICH of the cluster base station are allowed to overlap a PHICH and the PDCCH of the macro base station.

With reference to FIG. 7, the description is focused on a PDCCH. Because the PDCCH is used to transmit control information which enables a data channel to normally operate, transmission through the PDCCH is more important than transmission through another channel, and the PDCCH must have high stability. Therefore, as an embodiment, the description has been focused on the PDCCH. However, the present invention is not limited to this configuration, and includes a case of transmitting important control information related to data transmission. Accordingly, when multiple pieces of control information are transmitted, it is possible to configure such that the multiple pieces of control information are divided into the most important control information, important control information which is in the top N ranking, and control information which is not in the top N ranking, according to the importance of control information, and the transmission of the important control information through a network which is not a macro network overlaps the transmission of control information which is not important in another network. Namely, the most important control information may be configured in such a manner that an overlap between networks does not occur.

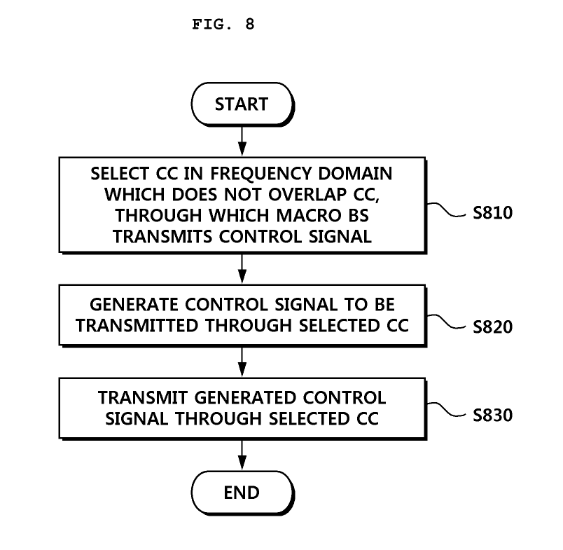

FIG. 8 is a flowchart showing a process of transmitting control information in an environment of heterogeneous wireless networks according to an embodiment of the present invention.

In the present invention, each of the local base stations forming the cluster base station may acquire information on component carriers, through which the macro base station transmits control signals, may avoid a relevant component carrier, and may select a component carrier for transmitting a control signal of each local base station. Because a control signal of the macro base station has higher power than that of a signal for transmitting the actual data, each of the local base stations forming the cluster base station needs to stably transmit a control signal thereof. FIG. 8 is a flowchart showing a process of transmitting a control signal in such a manner as to avoid interference caused by a control signal that the macro base station transmits in order to high power.

A selection is made of a component carrier in a frequency domain which does not overlap a component carrier, through which the macro base station transmits a control signal (S810). In an environment of heterogeneous wireless networks, in order to prevent the occurrence of interference between a control signal of the macro base station and a control signal of a local base station or the cluster base station, it is possible to consider the following method for avoiding the interference according to an embodiment of the present invention as described above.

First, when the macro base station uses five component carriers, control signals are included in some component carriers among the five component carriers, and only data is included in each of the other component carriers, as described above with reference to FIG. 4, there exists a scheme in which the local base station first includes a control signal in a component carrier in the same frequency domain as a component carrier, through which the macro base station transmits data, and then transmits the control signal through the component carrier.

To this end, there is a need for a process where the cluster base station identifies which component carrier of the macro base station includes a control signal. For this identification process, the four schemes are used as follows: 1) the scheme in which the cluster base station detects a signal transmitted by the macro base station, and identifies which component carrier a control signal is transmitted through, 2) the scheme in which the cluster base station first receives information on which component carrier the macro base station allocates a control signal to, or which component carrier the macro base station does not allocate a control signal to, through a gateway or a particular server existing in an upper layer of the cluster base station, and then refers to the received information, 3) the scheme in which information on component carriers used to transmit control signals is included in broadcasting information transmitted by the macro base station, and 4) the scheme in which cell planning causes a particular component carrier to have priority in the transmission of a control signal and enables the cluster base station to stably transmit the control signal.

When a cell coverage of the macro base station overlaps a cell coverage of a femto system (femto cell base station), a control signal may be stably transmitted through the process as described above. For example, the femto system may first include a control signal in a component carrier in the same frequency domain as a component carrier through which only data is transmitted among two or more component carriers used by the macro base station, and may then transmit the control signal included in the component carrier. In this case, a control signal transmitted by the macro base station does not overlap a control signal transmitted by the femto system.

As another embodiment, when the number of usable component carriers which may be used by the macro base station is equal to N, and the number of component carriers used by the macro base station is equal to K (K<N), a control signal may first be included in a component carrier in the same frequency domain as any one component carrier among (N-K) component carriers that the macro base station does not use, and may then be transmitted through the component carrier. For example, when the number of component carriers which may be used by the macro base station is equal to a total of 10 whereas the number of component carriers used by the macro base station is equal to 5, the femto system may first include a control signal in a component carrier (an unallocated component carrier) which the macro base station does not use, and may then transmit the control signal included in the unallocated component carrier.

As still another embodiment, a control signal may first be included in a component carrier in the same frequency domain as an extended component carrier among two or more component carriers used by the macro base station, and may then be transmitted through the component carrier.

Meanwhile, in order to avoid the overlap of PDCCHs among control signals, a PDCCH may first be included in a component carrier in the same frequency domain as a component carrier which does not include a PDCCH among two or more component carriers used by the macro base station, and may then be transmitted through the component carrier. As a result, a PHICH or a PCFICH may be included in the component carrier which does not include the PDCCH among the two or more component carriers used by the macro base station. In this case, a component carrier including a PDCCH transmitted by the macro base station does not overlap a component carrier including a PDCCH transmitted by the femto system. In the embodiments, the description is focused on a PDCCH. Because the PDCCH is used to transmit control information which enables a data channel to normally operate, transmission through the PDCCH is more important than transmission through another channel, and the PDCCH must have high stability. Therefore, as an embodiment, the description has been focused on the PDCCH. However, the present invention is not limited to this configuration, and includes a case of transmitting important control information related to data transmission. Accordingly, when multiple pieces of control information are transmitted, it is possible to configure such that the multiple pieces of control information are divided into the most important control information, important control information which is in the top N ranking, and control information which is not in the top N ranking, according to the importance of control information, and the transmission of the important control information through a network which is not a macro network overlaps the transmission of control information which is not important in another network. Namely, the most important control information may be configured in such a manner that an overlap between networks does not occur.

Although the above description is only an illustrative description of the technical idea of the present invention, those having ordinary knowledge in the technical field of the present invention will appreciate that various modifications, additions and substitutions are possible, without departing from the scope and spirit of the invention as disclosed in the accompanying claims. Therefore, the embodiments disclosed in the present invention are intended to illustrate the scope of the technical idea of the present invention, and the scope of the technical idea of the present invention is not limited by the embodiments. The protection scope of the present invention should be construed based on the accompanying claims, and all of the technical ideas included within the scope equivalent to the claims should be construed as being included within the right scope of the present invention.

1. A method for transmitting control information in a wireless communication system using two or more component carriers in an environment of heterogeneous wireless networks, the method comprising:
generating a control signal to be transmitted through a second component carrier in a frequency domain different from a frequency domain where a first component carrier, through which a macro base station transmits a control signal, is located; and
transmitting the control signal through the second component carrier.

2. The method as claimed in claim 1, wherein a third component carrier of the macro base station in a frequency domain overlapping a frequency domain where the second component carrier is located, corresponds to a component carrier through which data is transmitted.

3. The method as claimed in claim 1, wherein a third component carrier of the macro base station in a frequency domain overlapping a frequency domain where the second component carrier is located, corresponds to an unallocated component carrier.

4. The method as claimed in claim 1, wherein a third component carrier of the macro base station in a frequency domain overlapping a frequency domain where the second component carrier is located, corresponds to an extended component carrier.

5. The method as claimed in claim 1, wherein the control signal transmitted through the second component carrier corresponds to a physical downlink control channel (PDCCH), and a third component carrier of the macro base station in a frequency domain overlapping a frequency domain where the second component carrier is located, corresponds to a component carrier including a physical control format indicator channel (PCFICH) or a physical hybrid automatic repeat-request (HARQ) indicator channel (PHICH).

6. The method as claimed in claim 1, further comprising, before generating of the control signal, identifying whether a control signal is included in the first component carrier.

7. The method as claimed in claim 6, wherein, in identifying whether the control signal is included in the first component carrier, use is made of at least one of:
a first scheme in which a cluster base station detects a signal transmitted by the macro base station, and identifies which component carrier the control signal is transmitted through;
a second scheme in which the cluster base station receives information on which component carrier the macro base station allocates the control signal to, or which component carrier the macro base station does not allocate the control signal to, through a gateway or a particular server existing in an upper layer of the cluster base station, and refers to the received information;
a third scheme in which information on the component carriers used to transmit the control signals is included in broadcasting information transmitted by the macro base station; and
a fourth scheme in which cell planning causes a particular component carrier to have priority in the transmission of the control signal and enables the cluster base station to stably transmit the control signal.

8. The method as claimed in claim 1, wherein the wireless communication system has a smaller cell coverage than the macro base station, or has lower transmission power than the macro base station.

9. The method as claimed in claim 1, wherein the control signal transmitted through the second component carrier corresponds to a first control signal including control information required to normally transmit or receive data in a network, and wherein a third component carrier of the macro base station in a frequency domain overlapping a frequency domain where the second component carrier is located, corresponds to a component carrier including a control signal which is not the first control signal.

10. A method for transmitting a control signal in a femto system combined with a macro network, the method comprising:
when the number of usable component carriers that a macro base station is capable of using is equal to N, and the number of component carriers used by the macro base station is equal to K (K<N),
including a control signal in a component carrier in a frequency domain identical to a frequency domain where any one of (N-K) component carriers that the macro base station does not use, is located; and
transmitting the control signal included in the component carrier.

11. A method for receiving control information in an environment of heterogeneous wireless networks, the method comprising:
receiving a control signal through a first component carrier transmitted by a femto system, by a user equipment connected to a wireless communication system using two or more component carriers,
wherein the first component carrier is located in a frequency domain different from a frequency domain where a second component carrier, through which a macro base station transmits a control signal, is located.

12. A femto system combined with a macro network, the femto system comprising:
including a control signal in a second component carrier in a frequency domain identical to a frequency domain where a first component carrier among two or more component carriers used by a macro base station is located; and
transmitting the control signal included in the second component carrier,
wherein the first component carrier corresponds to any one of a component carrier through which data is not transmitted, an extended component carrier, an unallocated component carrier, and a component carrier which does not include a physical downlink control channel (PDCCH).

13. The femto system as claimed in claim 12, wherein, when the first component carrier corresponds to the component carrier which does not include the PDCCH, the first component carrier includes a physical hybrid automatic repeat-request (HARQ) indicator channel (PHICH) or a physical control format indicator channel (PCFICH).

14. The femto system as claimed in claim 12, wherein, in order to identify whether a control signal is included in the first component carrier before generating the control signal, the femto system uses at least one of:
a first scheme in which a cluster base station detects a signal transmitted by the macro base station, and identifies which component carrier the control signal is transmitted through;
a second scheme in which the cluster base station receives information on which component carrier the macro base station allocates the control signal to, or which component carrier the macro base station does not allocate the control signal to, through a gateway or a particular server existing in an upper layer of the cluster base station, and refers to the received information;
a third scheme in which information on the component carriers used to transmit the control signals is included in broadcasting information transmitted by the macro base station; and
a fourth scheme in which cell planning causes a particular component carrier to have priority in the transmission of the control signal and enables the cluster base station to stably transmit the control signal.

15. A user equipment, comprising:
the user equipment, being connected to a wireless communication system using two or more component carriers, to receive a control signal that a femto system transmits through a first component carrier,
wherein the first component carrier is located in a frequency domain different from a frequency domain where a second component carrier, through which a macro base station transmits a control signal, is located.
